(19) United States
(12) Patent Application Publication
(10) Pub. No.: US 2026/0303915 A1
(43) Pub. Date: Oct. 1, 2026

(54) PROCESSING METHOD, APPARATUS, DEVICE, MEDIUM, AND PRODUCT

(71) Applicant: Bytedance Technology Ltd., Grand Cayman (KY)

(72) Inventors: Lei MA, Beijing (CN); Yifan YANG, Beijing (CN)

(21) Appl. No.: 19/572,858

(22) Filed: Mar. 20, 2026

(30) Foreign Application Priority Data
Mar. 26, 2025 (CN) 202510368361.X

(51) Int. Cl. H04N 21/472

(52) U.S. Cl. CPC H04N 21/47217

(57) ABSTRACT

The present application discloses a processing method, apparatus, device, medium, and product. The method includes: providing, by a server, state information to a client, so that the state information is used to indicate request processing performance of the server, and the state information may represent a request processing speed of the server to some extent; and sending, by the client, a first request to the server when a playback progress of a first content sequence on the client reaches a progress threshold determined based on the state information, so that the server with the request processing performance may feed a second content sequence for playing and display after the first content sequence back to the client in response to the first request.

### CROSS-REFERENCE TO RELATED APPLICATIONS

The present application claims the benefit of priority to the Chinese patent application No. 202510368361.X filed with Chinese Patent Office on Mar. 26, 2025, which is hereby incorporated by reference in its entirety into the present application.

### TECHNICAL FIELD

The present application relates to the field of computer technologies, and in particular, to a processing method, apparatus, device, medium, and product.

### BACKGROUND

For some scenarios, such as a feed scenario, these scenarios have the following requirements: Content displayed on a client is obtained by the client requesting a server. For ease of understanding, description is provided below with reference to an example.

As an example, in a short video recommendation scenario, a client first sends a request to a server, so that the server may feed a short video back to the client based on the request; and then the client plays the received short video.

### SUMMARY

The present application provides a processing method, apparatus, device, medium, and product, which may better improve user experience.

To achieve the foregoing objective, the technical solutions provided in the present application are as follows:

The present application provides a processing method. The method is applied to a client, and the method includes: receiving state information provided by a server, where the state information is configured to indicate request processing performance of the server; and sending a first request to the server in response to a playback progress of a first content sequence on the client reaching a first threshold determined based on the state information, where the first threshold is positively correlated with the request processing performance, the first request is configured to request a second content sequence, and a playback time of a content at the first position in the second content sequence on the client is later than a playback time of a content at the tail position in the first content sequence on the client.

In a possible implementation, the state information is provided by the server in response to a second request sent by the client, and a sending time of the second request is earlier than a sending time of the first request.

In a possible implementation, the state information is determined based on a ratio of a number of requests borne by the server at a receiving time of the second request to a maximum number of bearable requests, the maximum number of bearable requests is obtained through quantity statistical analysis of requests borne by the server at various times in a historical time period, the first threshold is negatively correlated with the ratio, and the times in the historical time period are earlier than the receiving time of the second request.

In a possible implementation, a determining process of the state information includes: partitioning, based on at least one parameter, requests borne by the server at various times in a historical time period, to obtain at least one set, where there is no difference between parameter values of two requests partitioned into a same set under the at least one parameter, the at least one parameter includes a physical location and/or a request type, and the times in the historical time period are all earlier than the receiving time of the second request; performing, for any set, quantity statistical analysis on requests in the set, to obtain a maximum number of bearable requests corresponding to a parameter value of the set, wherein the parameter value of the set is configured to indicate parameter values of the requests in the set under the at least one parameter; and in response to the second request sent by the client, based on a parameter value specified by the second request under the at least one parameter, searching the maximum numbers of bearable requests corresponding to the parameter values of the at least one set for a maximum number of bearable requests corresponding to the specified parameter value, and determining the state information based on a ratio of a number of requests borne by the server at the receiving time of the second request to the maximum number of bearable requests corresponding to the specified parameter value, wherein the specified parameter value is configured to indicate a parameter value of the first request under the at least one parameter.

In a possible implementation, the second request is only configured to request the state information, and the second request is triggered in a polling manner.

In a possible implementation, the second request is a previous request corresponding to the first request, and the previous request is configured to request the first content sequence and the state information.

In a possible implementation, a sending time of a next request corresponding to the first request is determined based on state information fed back by the server for the first request, the sending time of the next request is later than the sending time of the first request, the next request is at least configured to request a third content sequence from the server, and a playback time of a content at the first position in the third content sequence on the client is later than a playback time of a content at the tail position in the second content sequence on the client.

In a possible implementation, the method further includes: receiving validity information provided by the server for the state information, where the validity information is configured to indicate a valid time period of the first threshold determined based on the state information; and sending the first request to the server in response to the playback progress of the first content sequence on the client reaching the first threshold determined based on the state information includes: sending the first request to the server in response to detecting, within the valid time period, that the playback progress of the first content sequence on the client reaches the first threshold.

In a possible implementation, the method further includes: sending a third request to the server in a polling manner in response to the playback progress of the first content sequence on the client not reaching the first threshold at an end time indicated by the valid time period, where a sending time of the third request is later than the end time; and sending the first request to the server in response to the playback progress of the first content sequence on the client reaching a second threshold determined based on state information fed back by the server for the third request.

In a possible implementation, the validity information provided by the server for the state information is determined based on the state information, a receiving time of the second request, and a change rule of the number of received requests obtained through quantity statistical analysis of requests received by the server at various times in a historical time period.

In a possible implementation, before sending the first request to the server, the method further includes: updating at least one timeout threshold based on the state information, where the at least one updated timeout threshold is configured to constrain at least part of stages in a sending process of the first request, each updated timeout threshold is negatively correlated with the request processing performance, the at least one updated timeout threshold includes a connection establishment timeout threshold, and the connection establishment timeout threshold is configured to indicate a maximum value of a duration consumed for establishing a data transmission connection between the client and the server for the first request.

The present application provides a processing apparatus, including: a receiving unit configured to receive state information provided by a server, where the state information is configured to indicate request processing performance of the server; and a sending unit configured to send a first request to the server in response to a playback progress of a first content sequence on the client reaching a first threshold determined based on the state information, where the first threshold is positively correlated with the request processing performance, the first request is configured to request a second content sequence, and a playback time of a content at the first position in the second content sequence on the client is later than a playback time of a content at the tail position in the first content sequence on the client.

The present application provides an electronic device. The device includes a processor and a memory. The memory is configured to store instructions or a computer program. The processor is configured to execute the instructions or the computer program in the memory, to enable the electronic device to perform the processing method provided in the present application.

The present application provides a computer-readable medium. The computer-readable medium stores instructions or a computer program. When the instructions or the computer program runs on a device, the device is enabled to perform the processing method provided in the present application.

The present application provides a computer program product, including a computer program carried on a non-transitory computer-readable medium. The computer program includes program codes for performing the processing method provided in the present application.

### BRIEF DESCRIPTION OF THE DRAWINGS

To describe the technical solutions in the embodiments of the present application or in the related art more clearly, the following briefly introduces the drawings required for describing the embodiments or the related art. Apparently, the drawings in the following description show merely some embodiments of the present application, and a person of ordinary skill in the art may still derive other drawings from these drawings without creative efforts.

FIG. 1 is a schematic diagram of a content obtaining process according to an embodiment of the present application;

FIG. 2 is a schematic diagram of obtaining new content in response to a user operation according to an embodiment of the present application;

FIG. 3 is a schematic diagram of obtaining new content through a pre-request with a fixed triggering timing according to an embodiment of the present application;

FIG. 4 is a schematic diagram of request processing performance of a server changing with time according to an embodiment of the present application;

FIG. 5 is a flowchart of a processing method according to an embodiment of the present application;

FIG. 6 is a schematic diagram of a dynamic update process of a request triggering timing according to an embodiment of the present application;

FIG. 7 is a schematic diagram of another dynamic update process of a request triggering timing according to an embodiment of the present application;

FIG. 8 is a schematic diagram of a dynamic update process of a timeout threshold according to an embodiment of the present application;

FIG. 9 is a schematic diagram of a structure of a processing apparatus according to an embodiment of the present application; and

FIG. 10 is a schematic diagram of a structure of an electronic device according to an embodiment of the present application.

### DETAILED DESCRIPTION OF EMBODIMENTS

Research has found that for some scenarios of a feed, such as a short video recommendation scenario, an information flow request process in this scenario is similar to the process shown in FIG. 1, and specifically as follows: When a user is browsing some content (such as short videos) that has been loaded by using a client, the user may trigger a specific operation (such as an up-sliding operation) on the client to express that the user desires to load more content. Therefore, when an interaction module of the client detects the operation, the interaction module may generate a content request based on the operation, so that the content request is used to convey a user requirement of “loading more content” to a network module of the client. In this way, the network module may send a dynamic application programming interface (API) request to a video stream server based on the content request, and the video stream server feeds content data back to the network module based on the dynamic API request, so that the content data is used to describe some features (such as an acquisition address of a short video, a number of comments on the short video, and a title of the short video) of new content that needs to be loaded to the client for display. In this way, when the network module feeds these features (streaming media description information shown in FIG. 1) described by the content data back to the interaction module, these features are rendered and displayed by the interaction module for the user to view. In addition, when there is an acquisition address of streaming media data (such as a short video) in these features, the interaction module may further send a streaming media request (also referred to as a static resource request) to the network module based on the address, so that the network module may obtain, from a streaming media server through network communication based on the address carried in the streaming media request, the streaming media data indicated by the address, and the network module feeds the streaming media data back to the interaction module, so that the interaction module may render and display the streaming media data for the user to view. Therefore, the user may see the new streaming media data and description information thereof on the client. It may be learned that the information flow request process is implemented by using both the dynamic API request and the static resource request, so that in the process, not only data (data such as a comment list of a short video) that may change with time may be obtained, but also data (data such as a video) that does not change with time may be obtained.

It should be noted that the dynamic API request is used to request data (data such as a comment list of a short video) that may change with time; and the static resource request is used to request data (streaming media data such as a short video indicated by a specific address or music indicated by a specific address) that does not change with time.

Research has further found that for any network request (such as a dynamic API request), a process of sending the network request by the client to the server specifically includes: after the network request is generated by the client, first performing, by the client, domain name system (DNS) resolution on a domain name carried in the network request, to obtain an internet protocol (IP) address of the server; and then requesting, by the client, the server indicated by the IP address to establish a data transmission connection under a specific protocol, such as the transmission control protocol (TCP), so that after the connection is successfully established, the network request is transmitted by the client to the server, and feedback data determined by the server for the network request is transmitted by the server to the client for use. It may be learned that a sending process of a network request may be roughly partitioned into three stages: DNS resolution, TCP connection establishment, and data transmission. Each stage has a specific time overhead. Therefore, to prevent the user experience from being affected by too long waiting time in each stage, a fixed timeout threshold (such as 5 seconds) may be configured for each stage. Once it is detected that a specific stage (such as TCP connection establishment) is not completed after the time consumed in the stage exceeds the timeout threshold configured for the stage, it may be determined that a timeout occurs in this stage, and therefore it is directly determined that the execution of this stage fails.

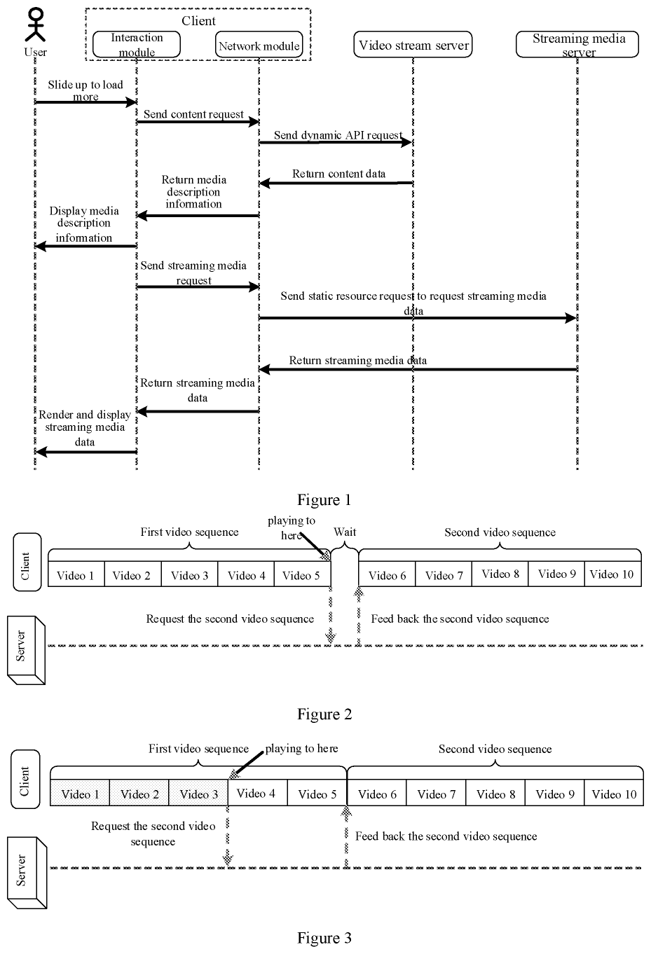

Research has further found that a specific time is consumed for a related process (such as a sending process) of a network request, so that in the manner (the request triggering manner shown in FIG. 2) in which a corresponding request is sent to a server only after a user requirement is determined based on a user operation, a phenomenon that a user needs to wait for a relatively long time to see new content easily occurs. This affects continuity of content playing and display, and further reduces user experience. As an example, as shown in FIG. 2, when a user is browsing a first video sequence that has been loaded on a client, if the user triggers an up-sliding operation when browsing to a last video (video 5 shown in FIG. 2) in the first video sequence on the client, to express that the user desires to load more videos, the client sends a network request to the server based on the up-sliding operation, so that subsequently, the server may feed a second video sequence back to the client in response to the network request, for the user to continue viewing. A specific time is consumed for the related process of the network request, so that there is a relatively long time interval between a time when the client obtains the second video sequence from the server for playing and a time when the user triggers the up-sliding operation on the client. Therefore, the user is in a waiting state in the time interval, and may feel obvious stuttering. This affects the user experience.

Research has further found that to overcome the defect described in the preceding paragraph, a manner of a pre-request may be used to obtain content that satisfies a user requirement. The pre-request is a manner of initiating a request in advance and caching a result, to reduce waiting time of a user operation, thereby improving user experience. As an example, as shown in FIG. 3, when a user is browsing a first video sequence that has been loaded on a client, if it is detected that a browsing progress of the user for the first video sequence reaches a preset fixed progress threshold (for example, two videos remain to be browsed), a network request is sent by the client to a server, so that subsequently, the server may feed a second video sequence back to the client in response to the network request. In this way, waiting time of the user may be reduced by triggering the network request in advance, which is favorable for improving continuity of user experience.

Research has further found that the solution described in the preceding paragraph is implemented by a pre-request with a fixed triggering timing (for example, the pre-request is triggered when two videos remain to be browsed). Therefore, the solution has the following two defects: (1) If the pre-request is triggered too early (for example, the pre-request is triggered when four videos remain to be browsed), although the continuity of user experience may be better ensured, waste of user traffic and service bandwidth resources easily occurs because content obtained in advance through the pre-request is not browsed by the user. This easily leads to a relatively high resource waste rate. (2) If the pre-request is triggered too late (for example, the pre-request is triggered when one video remains to be browsed), although the resource waste rate may be reduced, a time when the client obtains new content from a server is likely to be later than a time when a user operation is triggered, and therefore the new content still needs to be waited for a period of time to be obtained and played after the user operation is performed. This leads to deterioration of user experience. Based on these defects, it may be learned that the solution implemented by the pre-request with a fixed triggering time cannot achieve a good balance between user experience and resource waste.

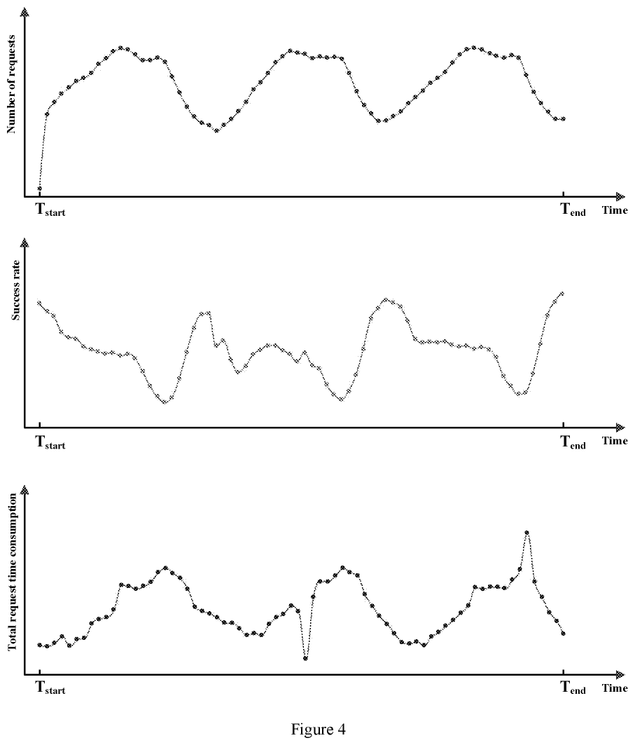

Research has further found that a large number of users may use an application (App) in a specific period of time, but only a small number of users use the App at other times, so that a number of requests processed by a server corresponding to the App varies in different periods of time, forming a phenomenon of peaks and valleys (the peaks and valleys shown in FIG. 4). In addition, when there are a relatively large number of requests, a network operator may limit a network speed, and the server needs to concurrently process a large number of requests, so that the requests sent to the server have a relatively large processing delay. As a result, both a success rate and a time consumption of the requests sent to the server deteriorate. Specifically, in the period of time [start time Tₛₜₐᵣₜ, end time T_{end}] shown in FIG. 4, when the number of requests reaches a peak, the success rate of request processing decreases, and the time consumption of request processing increases. Therefore, the server has a poor request processing performance. However, when the number of requests reaches a valley, the success rate of request processing rises, and the time consumption of request processing decreases. Therefore, the server has a good request processing performance. It may be learned that as the number of requests gradually increases, the request processing performance (such as the success rate of request processing and the time consumption of request processing) of the server gradually deteriorates. However, as the number of requests gradually decreases, the request processing performance of the server is gradually optimized.

Research has further found that for any server, due to differences in a request processing success rate and request processing time consumption that are presented by the server at different times, the server presents different request processing performance at the different times. Therefore, a process of obtaining content in advance from the server through a pre-request with a fixed triggering timing has different effects at the different times. For example, new content may be obtained before a user operation is performed in some cases, but the new content cannot be obtained before the user operation is performed in some other cases. This affects user experience.

Based on the foregoing research, to better improve user experience, the present application provides a processing method. The method includes: providing, by a server, state information to a client, so that the state information is used to indicate request processing performance of the server, and the state information may represent a request processing speed of the server to some extent; and sending, by the client, a first request to the server when a playback progress of a first content sequence on the client reaches a progress threshold determined based on the state information, so that the server with the request processing performance may feed a second content sequence for playing and display after the first content sequence back to the client in response to the first request. A progress threshold used to indicate a triggering timing (such as a sending time) of the first request is determined based on the state information provided by the server, so that the triggering timing of the first request is dynamically adjusted with continuous changes in the request processing performance of the server, instead of being fixed. This may effectively overcome the defect that exists when a request triggering timing is fixed. In addition, the progress threshold is positively correlated with the request processing performance indicated by the state information, so that the progress threshold is relatively large when the server has a good request processing performance (for example, a relatively fast response speed for a request), and the progress threshold is relatively small when the server has a poor request processing performance (for example, a relatively slow response speed for a request). Therefore, when the server has a good request processing performance, the first request needs to be sent when the first content sequence is almost finished playing, to reduce a resource waste rate. When the server has a poor request processing performance, the first request needs to be sent soon after the first content sequence starts playing, to reduce waiting time.

It may be learned that the triggering timing of the first request has the following characteristics: The first request is triggered as late as possible when the server has a good request processing performance, to reduce as much as possible waste of both user traffic and service bandwidth resources consumed when the second content sequence is obtained in advance due to the user leaving after viewing some content in the first content sequence; and the first request is triggered as early as possible when the server has a poor request processing performance, to ensure that the client has successfully obtained the second content sequence from the server before the first content sequence is finished playing, so that continuity of content playing on the client may be ensured. This may effectively avoid deterioration of user experience caused by the user having to wait for a period of time when the second content sequence is not obtained after the first content sequence is finished playing, thereby effectively improving user experience. Based on these characteristics, it may be learned that the technical solutions provided in the present application may better improve the balance between user experience and resource waste by dynamically determining the request triggering timing based on the actual request processing performance of the server, so that user experience may be improved on the premise that resource waste is reduced as much as possible.

To enable persons skilled in the art to better understand the solutions of the present application, the technical solutions in the embodiments of the present application are described below clearly and completely with reference to the drawings in the embodiments of the present application. Apparently, the described embodiments are merely some rather than all of the embodiments of the present application. All other embodiments obtained by a person of ordinary skill in the art based on the embodiments of the present application without creative efforts shall fall within the protection scope of the present application.

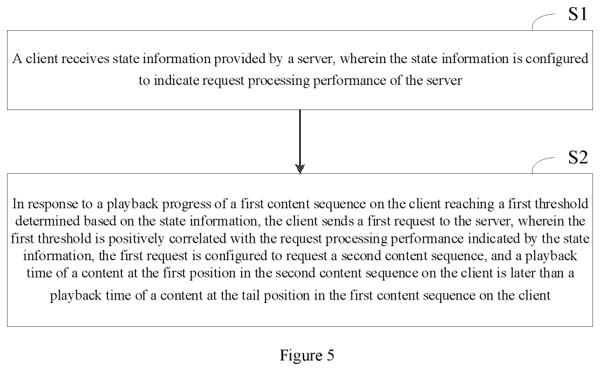

To better understand the technical solutions provided in the present application, the processing method provided in the present application is first described below with reference to some drawings. As shown in FIG. 5, the processing method provided in this embodiment of the present application includes the following steps S1 and S2.
S1: A client receives state information provided by a server, where the state information is used to indicate request processing performance of the server.

The state information is information that is provided by the server to the client and that is used to notify the client of a current state of the server, so that the state information may represent actual request processing performance of the server at a current moment. Therefore, the state information may represent characteristics such as a success rate and time consumption that are presented by the server in request processing at the current moment to some extent, so that the state information may represent a processing characteristic (such as time consumption and a success rate) of the server for a subsequent pre-request provided by the client.

It should be noted that the request processing performance is used to represent a superiority degree presented by the server when processing a request it receives; and the present application does not limit an implementation of the request processing performance. For example, the request processing performance may be implemented by using any indicator that may represent the superiority degree.

In addition, the present application does not limit a manner of providing the foregoing state information. For example, the server may send the state information to each client at intervals of a preset duration, so that these clients may learn about the current state of the server in a timely manner from the state information, so that subsequently, the clients may dynamically determine a triggering timing of the pre-request based on the current state.
S2: When a playback progress of a first content sequence on the client reaches a progress threshold determined based on the state information, the client sends a first request to the server, where the progress threshold is positively correlated with the request processing performance indicated by the state information, the first request is used to request a second content sequence, and a playback time of a content at the first position in the second content sequence on the client is later than a playback time of a content at the tail position in the first content sequence on the client.

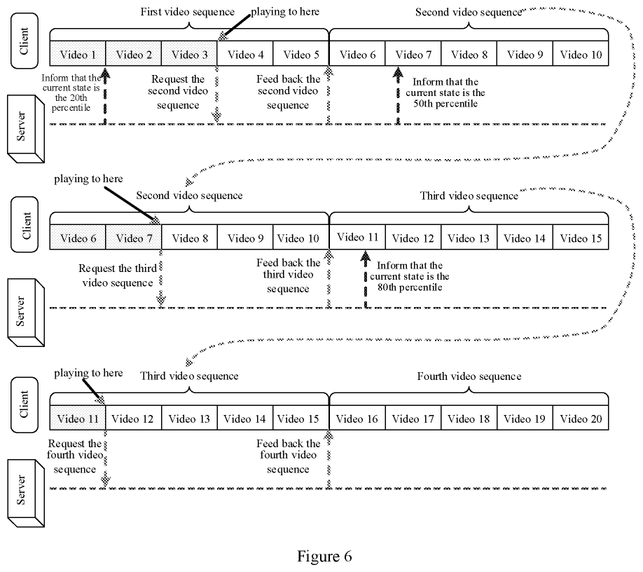

The first content sequence is a content sequence that has been obtained by the client from the server and that is being played and displayed by the client, for example, a first video sequence shown in FIG. 6, so that whether a triggering timing of the pre-request (such as the first request) is reached may be determined subsequently by determining whether the playback progress of the first content sequence on the client reaches the progress threshold determined based on the state information.

It may be learned that the progress threshold used to indicate the triggering timing of the pre-request (such as the first request) is determined based on the state information fed back by the server in real time, so that the triggering timing of the pre-request is dynamically adjusted with continuous changes in the request processing performance of the server, instead of being fixed. This may effectively overcome the defect that exists when the triggering timing of the pre-request is fixed. In addition, the progress threshold is positively correlated with the request processing performance indicated by the state information, so that the progress threshold is relatively large when the server has a good request processing performance (for example, a relatively fast response speed for a request), and the progress threshold is relatively small when the server has a poor request processing performance (for example, a relatively slow response speed for a request). Therefore, when the server has a good request processing performance, the pre-request needs to be sent when the first content sequence is almost finished playing, to reduce the resource waste rate. When the server has a poor request processing performance, the pre-request needs to be sent soon after the first content sequence starts playing, to reduce the waiting time. This helps improve user experience on the premise that resource waste is reduced as much as possible.

It should be noted that the present application does not limit a process of determining the foregoing progress threshold. For example, the progress threshold may be determined by using a pre-established mapping relationship. The mapping relationship is used to record progress thresholds corresponding to different pieces of state information, and the mapping relationship may be configured based on a requirement of an actual application scenario. For another example, the progress threshold may be determined by using a pre-trained machine learning model that may predict a progress threshold based on state information.

The first request is a pre-request that is automatically triggered by the client before a user operation is triggered and that is used to request the server to provide a content sequence for playing after the first content sequence is finished playing, for example, a request to “request a second video sequence” shown in FIG. 6, so that the second content sequence provided by the server in response to the request may be played and displayed by the client when the client detects the user operation. The second content sequence is a content sequence (a second video sequence shown in FIG. 6) that is requested in advance by the client from the server and that is used to play and display after the first content sequence when the client is playing and displaying the first content sequence.

It may be learned that for the client that is playing and displaying the first content sequence, after obtaining the state information provided by the server, the client first searches a pre-established mapping relationship for a progress threshold corresponding to the request processing performance indicated by the state information based on the request processing performance, so that the progress threshold may represent a triggering timing of the pre-request for obtaining the next content sequence (such as the second content sequence) in advance, and the progress threshold may represent how much content in the first content sequence remains to be played when the pre-request is triggered. Therefore, the progress threshold may reflect, to some extent, performance (such as time consumption) presented by the server when processing the pre-request at the current moment. Then, when it is detected that the playback progress of the first content sequence on the client reaches the progress threshold, it may be determined that the triggering timing of the pre-request is reached. Therefore, the pre-request may be directly sent by the client to the server, so that a time when the client obtains the next content sequence from the server is not later than a time when a user operation for requesting to play and display the next content sequence is triggered on the client, and a distance between the time when the client obtains the next content sequence from the server and the time when the user operation is triggered on the client is as small as possible (for example, less than a preset distance threshold). This may better improve the balance between user experience and resource waste, so that user experience may be improved on the premise that resource waste is reduced as much as possible.

It may be learned from the foregoing related content of S1 and S2 that the pre-request solution provided in the present application is implemented by dynamically determining a triggering timing of the pre-request based on the current state of the server. Therefore, the solution has the following characteristics: the pre-request (such as the first request) is triggered as late as possible when the server has a good request processing performance (for example, a relatively fast response speed for a request), to reduce as much as possible waste of both user traffic and service bandwidth resources consumed when the second content sequence is obtained in advance through the pre-request due to the user leaving after viewing some content in the first content sequence; and the pre-request is triggered as early as possible when the server has a poor request processing performance (for example, a relatively slow response speed for a request), to ensure that the client has successfully obtained the second content sequence from the server through the pre-request before the first content sequence is finished playing, so that continuity of content playing on the client may be ensured. This may effectively avoid deterioration of user experience caused by the user having to wait for a period of time when the second content sequence is not obtained after the first content sequence is finished playing, thereby effectively improving user experience. It may be learned that the technical solutions provided in the present application may better improve the balance between user experience and resource waste by dynamically determining the triggering timing of the pre-request based on the actual request processing performance of the server, so that user experience may be improved on the premise that resource waste is reduced as much as possible.

Research has found that the client needs to learn about the request processing performance of the server only in some periods of time. Therefore, when the server provides the state information to the client in a periodic distribution manner, a large amount of the state information is likely to be in an unused state, resulting in resource waste.

Based on the foregoing research, to better reduce resource waste, the foregoing state information may be provided by the server in response to a second request sent by the client, where a sending time of the second request is earlier than a sending time of the first request. In this way, the client may actively inquire of the server about its current state before the pre-request is triggered, so that resource waste caused when the server provides the state information to the client in a periodic distribution manner may be effectively overcome.

It may be learned that in a possible implementation, a process in which the server provides the state information to the client may specifically include: after receiving the second request sent by the client, the server may learn from the second request that the client needs to use (or query) the current state of the server, and therefore the server may query its current state in real time, so that the current state may represent the request processing performance of the server at a current moment (for example, a receiving moment of the second request); and the server feeds the current state back to the client, so that the client may learn about the request processing performance of the server at the current moment in a timely manner, so that the client may subsequently dynamically adjust the triggering timing of the pre-request based on the current state. This helps better improve user experience on the premise that resource waste is reduced as much as possible. It should be noted that the present application does not limit a manner of querying the current state. For example, any method that enables the server to query its own state may be used to implement querying the current state.

Research has found that for any time, if a number of requests that need to be processed simultaneously by the server (also referred to as being concurrent or borne by the server) at that time increases significantly, the request processing performance of the server will significantly deteriorate; but if the number of requests that need to be processed simultaneously by the server at that time is significantly reduced, the request processing performance of the server will be significantly improved. It may be learned that the number of requests borne by the server at that time affects the request processing performance of the server.

Research has further found that because different servers have different resources, maximum numbers of bearable requests of the different servers also differ. Therefore, the different servers present different processing effects when processing a same batch of concurrent requests (for example, some servers provide relatively few resources for this batch of concurrent requests, resulting in relatively poor processing effects for these requests; and some servers provide relatively sufficient resources for this batch of concurrent requests, resulting in relatively good processing effects for these requests). It may be learned that the maximum number of bearable requests of the server also affects the request processing performance of the server.

Based on the foregoing research, in some scenarios, such as a scenario in which the request processing performance needs to be evaluated in real time or a scenario in which the current state cannot be obtained through query, when the foregoing state information is provided by the server in response to the second request sent by the client, the state information may be determined based on a ratio of a number of requests (also referred to as a current number of borne requests) actually borne by the server at a receiving time of the second request to a maximum number of bearable requests obtained through quantity statistical analysis (such as maximum value analysis) on requests borne by the server at various times in a historical time period.

The foregoing ratio may represent a proportion of a resource already occupied by the server to a maximum resource that may be provided by the server at the current moment, so that the ratio may reflect, to some extent, how many resources the server may allocate to process a subsequent request it receives (such as the foregoing first request). Therefore, the state information determined based on the ratio may represent whether the server has sufficient resources to process a subsequent request at the current moment, so that the state information may better represent the request processing performance of the server. Therefore, a progress threshold determined based on the state information (for example, a progress threshold obtained by querying the state information from a mapping relationship shown in the following Table 1) may more accurately indicate when it is more appropriate to trigger the pre-request on the client. The mapping relationship is used to record progress thresholds corresponding to different states of the server.

TABLE 1
Progress thresholds corresponding to different states of the server

| Current state | Triggering timing of the pre-request |
|---|---|
| A current number of borne requests is a 20th percentile (for | The pre-request is actively triggered when |
| example, 20%) of the maximum number of bearable requests | two pieces of content remain to be played |
| A current number of borne requests is a 50th percentile (for | The pre-request is actively triggered when |
| example, 50%) of the maximum number of bearable requests | three pieces of content remain to be played |
| A current number of borne requests is an 80th percentile (for | The pre-request is actively triggered when |
| example, 80%) of the maximum number of bearable requests | four pieces of content remain to be played |
| . . . | . . . |

In addition, the foregoing ratio may represent a resource usage of the server at the current moment, so that the ratio may represent, to some extent, whether the number of requests already borne by the server at the current moment is in a peak state or a valley state. Therefore, the ratio may represent, to some extent, a duration consumed when the server processes the pre-request sent by the client (for example, the greater the ratio, the longer the duration, and the smaller the ratio, the shorter the duration). It may be learned that the ratio is negatively correlated with the request processing performance of the server (for example, the greater the ratio, the poorer the request processing performance, and the smaller the ratio, the better the request processing performance), so that the ratio may represent, to some extent, what the most appropriate triggering timing for the pre-request is at the current moment (for example, the greater the ratio, the earlier the triggering timing, and the smaller the ratio, the later the triggering timing). Therefore, the progress threshold used to indicate the triggering timing is negatively correlated with the ratio, so that the triggering timing of the pre-request may be accurately determined subsequently based on this relationship.

In addition, the various times in the foregoing historical time period are all earlier than the receiving time of the second request, so that the maximum number of bearable requests determined based on the historical time period may relatively accurately represent characteristics such as a maximum amount of resources used for request processing that is presented on the server by the receiving time of the second request. Therefore, the current state determined based on the maximum number of bearable requests may better describe the request processing performance of the server at the current moment.

It may be learned from the foregoing four paragraphs that the server may have at least the following functions: performing quantity statistical analysis on requests borne by the server every day, to obtain the maximum number of bearable requests (for example, 100,000 requests per second) of the server, so that the maximum number of bearable requests may represent a maximum amount of resources that may be used by the server in request processing; and after receiving a request that is used to inquire about a current state and that is sent by the client, the server first obtains an actual number of requests borne by the server at a current moment (for example, a receiving moment of the request), and then calculates a ratio (for example, a 20th percentile shown in FIG. 6 or Table 1) of the actual number of requests borne by the server at the current moment to the maximum number of bearable requests, so that the ratio may represent an amount of resources already used by the server in the current situation, and the ratio may represent, to some extent, how many resources the server may provide for a new request it receives subsequently in the current situation, and the ratio may represent the request processing performance of the server to some extent. Therefore, the ratio may be directly fed back to the client as the state information, so that the client may learn about the current request processing performance of the server based on the ratio, and the client may search a pre-established mapping relationship (such as the mapping relationship shown in Table 1) for a progress threshold corresponding to the ratio based on the ratio, as a triggering time of a pre-request (such as the foregoing first request) subsequently sent by the client. In this way, the triggering timing of the pre-request may be dynamically adjusted based on the actual state of the server.

Research has found that different types of requests vary in number change rule with time. For example, a peak of a first type of request (such as a consumption request) appears at 22:00, and a peak of a second type of request (such as a creation request) appears at 12:00. Therefore, the server presents different request processing performance for the different types of requests at the same time. In addition, requests triggered in different regions also vary in number change rule with time. For example, a peak of requests triggered in region 1 appears at 10:00, and a peak of requests triggered in region 1 appears at 15:00. Therefore, the server presents different request processing performance for the requests triggered in the different regions at the same time.

It may be learned based on the foregoing research that to better meet request processing requirements of different regions and different types, the server may perform resource division based on a region and a request type, so that different regions are allocated different resources, and different types of requests are allocated different resources. Therefore, different regions present different maximum numbers of bearable requests, and different types present different maximum numbers of bearable requests. Further, the server needs to determine the state information based on a type and a sending location of the pre-request provided by the client, so that the state information may more accurately represent the processing performance of the server for the pre-request.

It may be learned that in some scenarios, for example, a scenario in which a same server allocates different resources to different regions and different request types, when the foregoing state information is provided by the server in response to the second request sent by the client, a process of obtaining the state information may be as follows: First, the server partitions, based on at least one parameter (such as a physical location and/or a request type), the requests borne by the server at the various times in the historical time period, to obtain at least one set (for example, a set used to record a first type of request triggered in region A, and a set used to record a second type of request triggered in region B), so that there is no difference between parameter values of two requests partitioned into a same set under the at least one parameter, and there is a difference between parameter values of two requests partitioned into different sets under the at least one parameter. Therefore, the different sets may represent historical request bearing situations presented by the server under different parameter value combinations of the at least one parameter. Then, for any set, the server performs quantity statistical analysis (such as maximum value analysis) on requests in the set, to obtain a maximum number of bearable requests corresponding to a parameter value of the set, where the parameter value of the set is used to indicate parameter values of the requests in the set under at least one parameter. Then, in response to the second request sent by the client, the server searches, based on a parameter value (such as the sending location of the foregoing first request and/or the request type of the first request) specified by the second request under the at least one parameter, the maximum number of bearable requests corresponding to the parameter values of the set for a maximum number of bearable requests corresponding to the specified parameter value, and determines the state information based on a ratio of the number of requests actually borne by the server at the receiving time of the second request to the maximum number of bearable requests corresponding to the specified parameter value. The specified parameter value is used to indicate a parameter value of the first request under the at least one parameter, so that the maximum number of bearable requests corresponding to the specified parameter value that is obtained through querying may represent a maximum resource allocated by the server for the specified parameter value. Therefore, the state information determined based on the “maximum number of bearable requests corresponding to the specified parameter value” may more accurately represent the processing performance of the server for the pre-request (such as the first request) subsequently sent by the client, so that the progress threshold determined based on the state information may more accurately represent a triggering timing more suitable for the pre-request.

It should be noted that for the foregoing at least one parameter, the “at least one parameter” is a parameter based on which the server performs resource division, so that the “at least one parameter” may represent a parameter that needs to be provided when the client inquires of the server about a state; and the present application does not limit the “at least one parameter”. For example, the at least one parameter may include a physical location (such as a region in which the request is sent) and/or a request type.

It should be further noted that the foregoing “parameter value specified by the second request under the at least one parameter” is used to describe a characteristic presented by the pre-request (such as the first request) subsequently sent by the client under the at least one parameter; and the present application does not limit the “parameter value specified by the second request under the at least one parameter”. For example, the “parameter value specified by the second request under the at least one parameter” may include a sending location (such as a sending region) of the pre-request and/or a request type to which the pre-request belongs.

It may be learned from the foregoing four paragraphs that the server may have at least the following functions: separately counting, every day, a number of requests borne by the server in different regions and of different request types, to obtain a maximum number of bearable requests of the server in different combinations each composed of a region and a request type (for example, a maximum number of bearable requests of a first type of request in region A is 100,000 requests per second, and a maximum number of bearable requests of a second type of request in region B is 50,000 requests per second), so that the maximum number of bearable requests corresponding to each combination may represent a maximum amount of resources that may be used by the server for processing requests in each combination; and after receiving a request (such as the second request) that is used to inquire about the current state and that is sent by the client, the server first determines, based on the request, a sending location (such as region A) and a request type (the first type of request) of the pre-request subsequently sent by the client; then obtains a number of requests that are actually borne by the server at the current moment, that are triggered in the region indicated by the sending location, and that belong to the request type, as the current number of borne requests; and then calculates a ratio of the current number of borne requests to the maximum number of bearable requests (for example, the foregoing 100,000 requests per second) of the server in the combination composed of the sending location and the request type, so that the ratio may represent an amount of resources already used, at the current moment, by the server from request processing resources allocated by the server for the “combination composed of the sending location and the request type”, and the ratio may represent, to some extent, how many resources the server may provide, at the current moment, for a new request received subsequently in the “combination composed of the sending location and the request type”, and the ratio may represent, to some extent, the request processing performance presented by the server in the “combination composed of the sending location and the request type”. Therefore, the ratio may be directly fed back to the client as the state information, so that the client may learn about the current request processing performance of the server based on the ratio, and the client may search a pre-established mapping relationship for a progress threshold corresponding to the ratio based on the ratio, as the triggering timing of the pre-request (such as the first request) provided by the client. In this way, the triggering timing may be dynamically set for the pre-requests that are triggered in different regions and that belong to different request types at different times, which helps better improve user experience on the premise that resource waste is reduced as much as possible.

Research has found that to ensure that the client may obtain the request processing performance of the server in real time as much as possible, the client may continuously query the request processing performance of the server by sending an independent network request in a polling manner (a state query manner shown in FIG. 6).

It may be learned based on the foregoing research that in a possible implementation, when the foregoing state information is provided by the server in response to the second request sent by the client, the second request is only used to request the state information from the server, and the second request is triggered in the polling manner. In this way, the client may obtain the current state of the server by periodically sending an independent network request at a specific interval, which helps ensure that the client may obtain the latest state of the server in a timely manner, and helps ensure that the subsequent triggering timing of the pre-request is better.

It may be learned that in some scenarios, such as a scenario in which resources are sufficient or a scenario in which relatively high accuracy is required, the foregoing client has at least the following functions: The client sends a request used to inquire about the current state of the server to the server at intervals of a preset duration (for example, 10 minutes), so that the server may feed real-time state information of the server back to the client based on the request. This helps improve real-time performance of the state information, thereby helping improve a triggering effect of the pre-request.

Research has found that in some scenarios, for example, a scenario in which the user browses content at a relatively fast speed, the client may send a plurality of pre-requests in a short period of time. Therefore, to better save resources, a request for inquiring about the current state of the server may be integrated into the pre-request, so that the server may not only feed back a content sequence of a current request based on the pre-request, but may also feed back, based on the pre-request, state information used to affect a sending timing of a next pre-request. In this way, a plurality of types of information may be obtained by using one request, which helps better save resources.

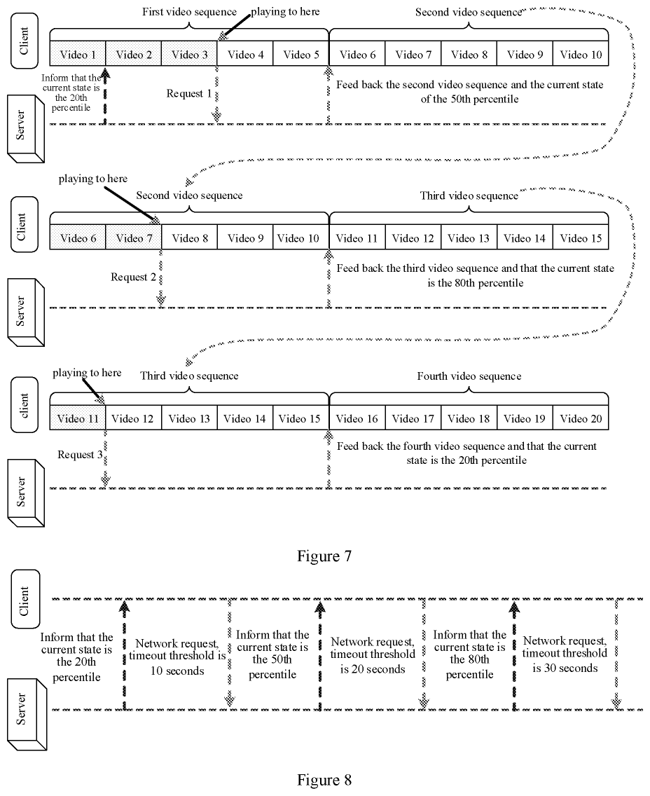

It may be learned based on the foregoing research that in a possible implementation, for the client that is playing the first content sequence (a second video sequence shown in FIG. 7), when the foregoing state information is provided by the server in response to the second request (request 1 shown in FIG. 7) sent by the client, the state information is used to affect the triggering timing of the first request (request 2 shown in FIG. 7) sent by the client, and the sending time of the second request is earlier than the sending time of the first request, the second request is a previous request (request 1 shown in FIG. 7) corresponding to the first request, and the previous request is used to request the first content sequence and the state information, so that the server may not only provide the first content sequence to the client based on the previous request, but may also provide, to the client based on the previous request, the state information used to affect the triggering timing of the next pre-request (request 2 shown in FIG. 7) corresponding to the previous request. This may effectively overcome the defect of resource waste caused when the state information of the server is obtained by sending the independent network request, thereby helping better save resources.

It may be learned that to better save resources, for the first request (request 2 shown in FIG. 7) sent by the client, the server not only provides the second content sequence (a third video sequence shown in FIG. 7) to the client based on the first request, but also provides new state information (a current state is an 80th percentile as shown in FIG. 7) to the client based on the first request, so that a sending time of the next request (request 3 shown in FIG. 7) corresponding to the first request is determined based on the state information fed back by the server for the first request. The sending time of the next request is later than the sending time of the first request. The next request is at least used to request a third content sequence (a fourth video sequence shown in FIG. 7) from the server. A playback time of first content in the third content sequence on the client is later than a playback time of last content in the second content sequence requested by the first request on the client. In this way, the triggering timing of the next pre-request in two adjacent pre-requests sent by the client is determined based on feedback content provided by the server for the previous pre-request. This helps greatly reduce the number of requests that need to be triggered to query the current state of the server in real time as much as possible, thereby helping better save resources.

It may be learned from the foregoing two paragraphs that in some scenarios, such as a scenario in which resources are limited, as shown in FIG. 7, the foregoing client has at least the following functions: after the client is started, first playing, on the client, a pre-loaded content sequence 1 (a first video sequence shown in FIG. 7) for the user to watch, so that the client sends, during playing of the content sequence 1, an independent network request used to inquire about the current state of the server to the server, so that the server may feed state information 1 (state information that a current state is a 20th percentile as shown in FIG. 7) back to the client based on the network request; then determining, by the client based on the current state described by the state information 1, a triggering timing of a pre-request 1 (request 1 shown in FIG. 7), so that the client sends the pre-request 1 to the server when the triggering timing is reached, to obtain a content sequence 2 (a second video sequence shown in FIG. 7) that needs to be played after the content sequence 1 and state information 2 (state information that a current state is a 50th percentile as shown in FIG. 7) that is used to affect a triggering timing of a next pre-request; subsequently, determining, by the client based on the current state described by the state information 2, a triggering timing of a pre-request 2 (request 2 shown in FIG. 7), so that the client sends the pre-request 2 to the server when the triggering timing is reached, to obtain a content sequence 3 (a third video sequence shown in FIG. 7) that needs to be played after the content sequence 2 and state information 3 (state information that a current state is an 80th percentile as shown in FIG. 7) that is used to affect a triggering timing of a next pre-request; . . . (and so on); until the client is closed.

Research has found that in some cases, after receiving the content sequence and the state information that are fed back by the server for the current pre-request, if the client watches the same content in the content sequence for a long time or directly closes the client under the influence of some factors, a duration between a time when the user needs to send the next pre-request when resuming normal content browsing on the client and a time when the client receives, from the server, the state information fed back by the server for the current pre-request is likely to be long. Therefore, the state information fed back by the server for the current pre-request may hardly correctly describe the request processing performance of the server when the next pre-request is triggered. Therefore, it is difficult for the triggering timing indicated by the progress threshold determined based on the state information to be suitable for the next pre-request. In this way, the resource waste rate is likely to be increased due to an excessively early triggering timing of the next pre-request, or a duration of waiting of the user for the next content sequence is likely to be increased due to an excessively late triggering timing of the next pre-request.

Based on the foregoing research, to better overcome the foregoing problem, the present application provides an implementation of the foregoing client. In this implementation, the client receives not only the first content sequence and the state information that are fed back by the server for the previous request (such as the foregoing second request) corresponding to the first request, but also the validity information provided by the server for the state information, so that the validity information is used to indicate the valid time period of the request processing performance of the server described by the state information, and thus the validity information is also used to indicate a valid time period of the progress threshold determined based on the state information, so that the client may learn from the validity information a duration for which the progress threshold is continuously valid, so that subsequently, in response to detecting that the playback progress of the first content sequence on the client reaches the progress threshold within the valid time period, the client sends the first request to the server. In this way, only the valid progress threshold may be used to affect the triggering timing of the pre-request, so that the defect caused when the triggering timing of the pre-request is affected by using an invalid progress threshold may be better avoided.

In addition, to better overcome an impact caused by expiration of the progress threshold or the state information, the present application provides an implementation of the foregoing client. In this implementation, the client is configured to receive not only the first content sequence, the state information, and the validity information that are fed back by the server for the previous request (such as the foregoing second request) corresponding to the first request and that are used to indicate the valid time period of the progress threshold determined based on the state information, but also send, in response to the playback progress of the first content sequence on the client still not reaching the progress threshold at the end time indicated by the valid time period, a third request (such as an independent network request used only to inquire about the current state of the server) to the server in the polling manner, where a sending time of the third request is later than the end time, so that the client may continuously inquire of the server about its current state; and send the first request to the server in response to the playback progress of the first content sequence on the client reaching a progress threshold determined based on state information fed back by the server for the third request (such as a latest sent third request). In this way, the adverse impact caused by expiration of the state information fed back by the server for the previous pre-request due to an excessively long interval between two adjacent pre-requests sent by the client may be overcome by switching to the manner in which the independent network request is sent in the polling manner, which helps better improve user experience on the premise that resource waste is reduced as much as possible.

It may be learned from the foregoing two paragraphs that in some scenarios, for the client, after the client receives the content sequence, the state information, and the corresponding validity information that are fed back by the server for the current pre-request, if the user leaves the client for some reasons or watches the content sequence for a long time, the state information expires due to long-term non-use. Therefore, the time threshold determined based on the state information also expires. Therefore, the triggering timing of the pre-request indicated by the time threshold may hardly be suitable for the next pre-request subsequently triggered by the client. Therefore, the new state information may be continuously obtained from the server by sending the independent network request in the polling manner, so that when the user resumes normal content browsing on the client, the triggering timing of the next pre-request may be determined by using the latest state information. This helps better improve user experience on the premise that resource waste is reduced as much as possible.

It should be noted that the present application does not limit an implementation of the foregoing validity information. For example, the validity information may be implemented by using any information that may describe a valid time period of information, such as information about a time period, or a valid duration, or a deadline.

It should be further noted that the present application does not limit a manner of obtaining the foregoing validity information. For example, the validity information may be fixed information preset based on an actual application scenario, such as information that a valid duration is 3 minutes, a valid time period is a specific time period, or a deadline is a specific time point.

Research has found that due to differences in the number of requests presented by the server in different periods of time, it is difficult for the fixed validity information to meet change rules of the number of requests presented in the different periods of time. Therefore, a state update process determined based on the fixed validity information may hardly adapt to update requirements for the change in the number of requests in each period of time, thereby affecting a determination effect of the triggering timing of the pre-request.

Research has further found that the number of requests presented by the server in different periods of time of a same day is different, but the change rule of the number of requests presented by the server in the different periods of time of the same day is almost fixed.

It may be learned from the foregoing two paragraphs of research that to better overcome the problem caused by the fixed validity information, when the foregoing state information is provided by the server in response to the second request (such as the previous request corresponding to the first request) sent by the client, the validity information provided by the server for the state information is determined based on the state information, a receiving time of the second request, and the change rule of the number of received requests obtained through quantity statistical analysis on requests received by the server at various times in the historical time period. The “change rule of the number of received requests” is obtained through statistical analysis on historical data of the server, so that the “change rule of the number of received requests” may better represent a relatively fixed change in the number of received requests presented by the server in different periods of time of the same day. Therefore, the validity information determined based on the “change rule of the number of received requests” may represent a duration, indicated by the “change rule of the number of received requests”, during which the state information determined by the server at the receiving time of the second request does not change or slightly changes within a specific range. Therefore, the validity information may represent a time point to which the state information may last and does not change drastically from the receiving time of the second request as determined based on the historical data of the server. In this way, the triggering timing of the pre-request determined under the constraint of the validity information is more accurate, which helps better improve user experience on the premise that resource waste is reduced as much as possible. For ease of understanding, the following describes an example.

For example, when receiving, at 10:00, the pre-request sent by the client, the server not only obtains a new content sequence and state information based on the pre-request, but also analyzes a valid time period of the state information based on the foregoing “change rule of the number of received requests obtained through quantity statistical analysis on requests received by the server at various times in the historical time period”, to obtain the following analysis result: The state information remains unchanged or slightly changes within a specific range from 10:00 to a target time (such as 11:00), but the state of the server changes drastically after the target time. Therefore, the server may learn from the analysis result that the valid time period of the state information is the period of time [10:00, target time], so that the server may subsequently determine the period of time [10:00, target time] as the validity information provided by the server for the state information, and feed the validity information back to the client, so that the client may learn from the validity information that the valid time period of the request processing performance described by the state information is the period of time [10:00, target time], and the client may learn from the validity information that the valid time period of the progress threshold determined based on the state information is the period of time [10:00, target time], so that the client may determine the triggering timing of the pre-request under the constraint of the validity information. This helps better improve user experience on the premise that resource waste is reduced as much as possible.

Research has found that due to different request processing performance presented by the server at different times, the server spends different amounts of time processing a same network request at the different times. Therefore, when a timeout threshold (such as a timeout threshold for TCP connection establishment) involved in the pre-request is implemented by using a fixed duration, the following defects exist: (1) If the timeout threshold is set to be too long (for example, 60 seconds), the user keeps waiting for the pre-request in a weak network scenario, and is not promptly prompted that the network is poor, resulting in invalid waiting of the user; and (2) if the timeout threshold is set to be too short (for example, 3 seconds), a request success rate may be caused to decline. For example, a current pre-request may successfully establish a TCP connection in the fourth second, but is determined as a connection failure due to the expiration of the timeout threshold in the third second, causing the network request to be actively disconnected. It may be learned from these defects that the fixed timeout threshold cannot adapt to the request processing performance presented by the server in different periods of time, resulting in a low network request success rate and a long time consumption.

Based on the foregoing research, to better solve the foregoing problem, the present application further provides a possible implementation of the processing method. In this implementation, the processing method may include at least the following steps: after receiving the state information provided by the server, the client updates at least one timeout threshold (such as a timeout threshold for TCP connection establishment) based on the state information, so that the at least one updated timeout threshold is used to constrain some or all stages (such as the TCP connection establishment stage) in a sending process of the first request subsequently provided by the client, each updated timeout threshold is negatively correlated with the request processing performance specified by the state information (for example, the better the request processing performance, the smaller the timeout threshold, or the worse the request processing performance, the larger the timeout threshold, or a mapping relationship shown in Table 2 below, or a correspondence shown in FIG. 8), and the at least one updated timeout threshold includes a connection establishment timeout threshold, the connection establishment timeout threshold is used to indicate a maximum value of a duration allowed to be consumed for establishing a data transmission connection (such as a TCP connection) between the client and the server for the first request. In this way, the timeout threshold may be dynamically determined based on the request processing performance of the server (for example, different timeout thresholds are dynamically determined for pre-requests of different types in different regions at different times), so that the defect caused by the fixed timeout threshold may be effectively overcome. It should be noted that the present application does not limit an implementation of the “some or all stages”. For example, when the sending process of the first request includes a domain name resolution stage (such as a DNS resolution stage), a connection establishment stage (such as the TCP connection establishment stage), and a data transmission stage, the “some or all stages” may include at least the connection establishment stage.

TABLE 2
Timeout thresholds corresponding to the server in different request processing states

| Current state | Timeout threshold |
|---|---|
| A current number of borne requests is a 20th percentile (for | The timeout threshold for the TCP |
| example, 20%) of the maximum number of bearable requests | connection establishment is 10 seconds. |
| A current number of borne requests is a 50th percentile (for | The timeout threshold for the TCP |
| example, 50%) of the maximum number of bearable requests | connection establishment is 20 seconds. |
| A current number of borne requests is an 80th percentile (for | The timeout threshold for the TCP |
| example, 80%) of the maximum number of bearable requests | connection establishment is 30 seconds. |
| . . . | . . . |

It may be learned from the foregoing related content of the processing method that the implementation solution of the pre-request provided in the present application may be as follows: it is difficult for the client to perceive peaks and valleys of requests because the client is an independent individual. Therefore, the server needs to perceive and identify the peaks and valleys of the requests, so that at the peak, because an App is in a usage peak period, it may be inferred that the user tends to continue viewing content recommended by the App, and therefore triggering the pre-request earlier does not cause a high resource waste rate; but at the valley, because the App is in a usage valley period, it may be inferred that the user tends not to continue viewing the content recommended by the App, and therefore triggering the pre-request later may avoid causing a high resource waste rate. It may be learned based on this that the server needs to separately perform statistics collection for different regions and different request types, to determine a maximum number of bearable requests of the server for each request type in each region, so that the server may subsequently transmit the current state (for example, a percentile of the number of requests borne at the current moment to the maximum number of bearable requests) to the client in a specific manner, so that the client may dynamically determine, based on the current state, the triggering timing of the pre-request and some timeout thresholds (such as the timeout threshold for TCP connection establishment) of the pre-request. This helps dynamically determine the triggering timing of the pre-request and the timeout threshold for the pre-requests of different types in different regions at different times, so that the solution has the advantages shown in the following (1) to (3).
(1) User experience is optimized. Specifically, because a network request delay is relatively large at the peak, the pre-request is triggered earlier to ensure coherence of user experience and reduce waiting; and because a network request delay is relatively small at the valley, the timeout threshold for the TCP connection establishment and other stages is reduced to enable a fast failure and reduce invalid waiting.
(2) Resource waste is reduced. Specifically, because the network request delay is relatively small at the valley, the pre-request is triggered later, reducing waste of the user's traffic and the service bandwidth resources.
(3) A network request success rate is improved. Specifically, because the network request delay is relatively large at the peak, increasing the timeout threshold for the TCP connection establishment and other stages may effectively improve the network request success rate.

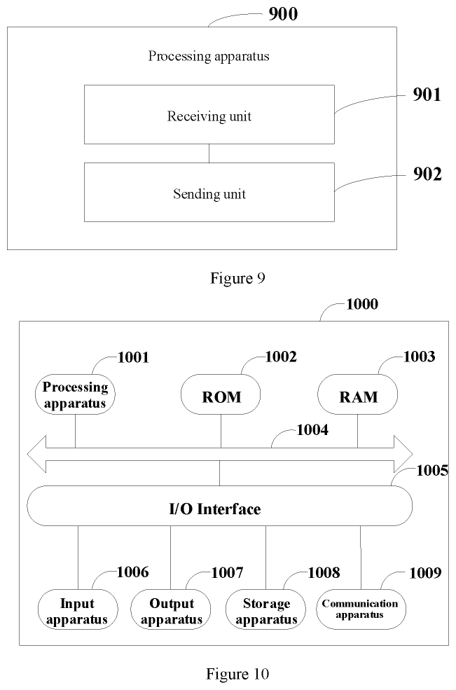

Based on the processing method provided in the embodiment of the present application, an embodiment of the present application further provides a processing apparatus. The following explains and describes the processing apparatus with reference to FIG. 9. FIG. 9 is a schematic diagram of a structure of a processing apparatus according to an embodiment of the present application. For technical details of the processing apparatus provided in the embodiment of the present application, refer to the foregoing related content of the processing method.

As shown in FIG. 9, the processing apparatus 900 provided in this embodiment of the present application includes:
a receiving unit 901 configured to receive state information provided by a server, where the state information is used to indicate request processing performance of the server; and
a sending unit 902 configured to send a first request to the server in response to a playback progress of a first content sequence on a client reaching a progress threshold determined based on the state information, where the progress threshold is positively correlated with the request processing performance, the first request is used to request a second content sequence, and a playback time of a content at the first position in the second content sequence on the client is later than a playback time of a content at the tail position in the first content sequence on the client.

In a possible implementation, the state information is provided by the server in response to a second request sent by the client, and a sending time of the second request is earlier than a sending time of the first request.

In a possible implementation, the state information is determined based on a ratio of an actual number of requests borne by the server at a receiving time of the second request to a maximum number of bearable requests obtained through quantity statistical analysis of requests borne by the server at various times in a historical time period, the progress threshold is negatively correlated with the ratio, and the various times in the historical time period are all earlier than the receiving time of the second request.

In a possible implementation, a determining process of the state information includes: partitioning, based on at least one parameter, requests borne by the server at various times in a historical time period, to obtain at least one set, where there is no difference between parameter values of two requests partitioned into a same set under the at least one parameter, and there is a difference between parameter values of two requests partitioned into different sets under the at least one parameter, the at least one parameter includes a physical location and/or a request type, and the various times in the historical time period are all earlier than the receiving time of the second request; performing, for any set, quantity statistical analysis on requests in the set, to obtain a maximum number of bearable requests corresponding to a parameter value of the set, where the parameter value of the set is used to indicate parameter values of the requests in the set under the at least one parameter; and in response to the second request sent by the client, based on a parameter value specified by the second request under the at least one parameter, searching the maximum numbers of bearable requests corresponding to the parameter values of the at least one set for a maximum number of bearable requests corresponding to the specified parameter value, and determining the state information based on a ratio of an actual number of requests borne by the server at the receiving time of the second request to the maximum number of bearable requests corresponding to the specified parameter value, where the specified parameter value is used to indicate a parameter value of the first request under the at least one parameter.

In a possible implementation, the second request is only used to request the state information, and the second request is triggered in a polling manner.

In a possible implementation, the second request is a previous request corresponding to the first request, and the previous request is used to request the first content sequence and the state information.

In a possible implementation, a sending time of a next request corresponding to the first request is determined based on state information fed back by the server for the first request, the sending time of the next request is later than the sending time of the first request, the next request is at least used to request a third content sequence from the server, and a playback time of a content at the first position in the third content sequence on the client is later than a playback time of a content at the tail position in the second content sequence on the client.

In a possible implementation, the receiving unit 901 is further configured to receive validity information provided by the server for the state information, where the validity information is used to indicate a valid time period of the progress threshold determined based on the state information; and

the sending unit 902 is specifically configured to send the first request to the server in response to detecting, within the valid time period, that the playback progress of the first content sequence on the client reaches the progress threshold.

In a possible implementation, the sending unit 902 is further configured to: send a third request to the server in a polling manner in response to the playback progress of the first content sequence on the client not reaching the progress threshold at an end time indicated by the valid time period, where a sending time of the third request is later than the end time; and send the first request to the server in response to the playback progress of the first content sequence on the client reaching a progress threshold determined based on state information fed back by the server for the third request.

In a possible implementation, the validity information provided by the server for the state information is determined based on the state information, a receiving time of the second request, and a change rule of the number of received requests obtained through quantity statistical analysis of requests received by the server at various times in a historical time period.

In a possible implementation, the processing apparatus 900 further includes an updating unit. The updating unit is configured to update at least one timeout threshold based on the state information before the first request is sent to the server, where the at least one updated timeout threshold is used to constrain some or all stages in a sending process of the first request, each updated timeout threshold is negatively correlated with the request processing performance, the at least one updated timeout threshold includes a connection establishment timeout threshold, and the connection establishment timeout threshold is used to indicate a maximum value of a duration consumed for establishing a data transmission connection between the client and the server for the first request.

In a possible implementation, the processing apparatus 900 is the client provided in the present application, or the client is deployed on the processing apparatus 900.

It may be learned from the foregoing related content of the processing apparatus 900 that a working principle of the apparatus 900 includes: The server provides the state information for the apparatus 900, so that the state information is used to indicate the request processing performance of the server, and the state information may represent a request processing speed of the server to some extent. Therefore, when a playback progress of the first content sequence on the apparatus 900 reaches the progress threshold determined based on the state information, the apparatus 900 sends the first request to the server, so that the server with the request processing performance may feed the second content sequence arranged after the first content sequence for playing and display back to the apparatus 900 for the first request. This helps improve user experience while reducing resource waste as much as possible.

In addition, an embodiment of the present application further provides an electronic device. The device includes a processor and a memory. The memory is configured to store instructions or a computer program. The processor is configured to execute the instructions or the computer program in the memory, to enable the electronic device to perform any implementation of the processing method provided in the embodiments of the present application.

FIG. 10 is a schematic diagram of a structure of an electronic device 1000 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PDA), a portable media player (PMP), and a vehicle-mounted terminal (such as a vehicle navigation terminal), and fixed terminals such as a digital TV and a desktop computer. The electronic device shown in FIG. 10 is merely an example, and shall not impose any limitation on the function and the range of use of the embodiment of the present disclosure.

As shown in FIG. 10, the electronic device 1000 may include a processing apparatus (e.g., a central processing unit, a graphics processor, etc.) 1001 that may perform various appropriate actions and processes according to a program stored in a read-only memory (ROM) 1002 or a program loaded from a storage apparatus 1008 into a random access memory (RAM) 1003. The RAM 1003 further stores various programs and data required for operations of the electronic device 1000. The processing apparatus 1001, the ROM 1002, and the RAM 1003 are interconnected by means of a bus 1004. An input/output (I/O) interface 1005 is also connected to the bus 1004.

Usually, the following apparatuses may be connected to the I/O interface 1005: an input apparatus 1006 including, for example, a touch screen, a touchpad, a keyboard, a mouse, a camera, a microphone, an accelerometer, and a gyroscope; an output apparatus 1007 including, for example, a liquid crystal display (LCD), a speaker, and a vibrator; the storage apparatus 1008 including, for example, a magnetic tape and a hard disk; and a communication apparatus 1009. The communication apparatus 1009 may allow the electronic device 1000 to communicate wirelessly or wiredly with other devices to exchange data. Although FIG. 10 shows the electronic device 1000 having various apparatuses, it should be understood that not all the apparatuses shown herein need to be implemented or provided. Alternatively, more or fewer apparatuses may be implemented or provided.

In particular, according to the embodiments of the present disclosure, the process described above with reference to the flowcharts may be implemented as a computer software program. For example, the embodiments of the present disclosure include a computer program product, which includes a computer program carried on a non-transitory computer-readable medium, where the computer program includes program codes for performing the method shown in the flowchart. In such an embodiment, the computer program may be downloaded and installed from a network via the communication apparatus 1009, or installed from the storage apparatus 1008, or installed from the ROM 1002. When the computer program is executed by the processing apparatus 1001, the foregoing functions defined in the method of the embodiments of the present disclosure are executed.

The electronic device provided in this embodiment of the present disclosure belongs to the same inventive concept as the method provided in the foregoing embodiments. For technical details not described in detail in this embodiment, reference may be made to the foregoing embodiments, and this embodiment has the same beneficial effects as the foregoing embodiments.

An embodiment of the present application further provides a computer-readable medium. The computer-readable medium stores instructions or a computer program. When the instructions or the computer program runs on a device, the device is enabled to perform any implementation of the processing method provided in the embodiments of the present application.

It should be noted that the foregoing computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated on a baseband or as a part of a carrier, and computer-readable program code is carried in the data signal. The data signal propagated in this way may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program codes contained on the computer-readable medium may be transmitted in any suitable medium, including, but not limited to, a wire, an optical cable, a radio frequency (RF), or any suitable combination thereof.

In some implementations, the client and the server may communicate using any currently known or future developed network protocol, such as the hyper text transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The foregoing computer-readable medium may be contained in the foregoing electronic device, or may exist alone without being assembled into the electronic device.

The foregoing computer-readable medium carries one or more programs, and when the one or more programs are executed by the electronic device, the electronic device may perform the foregoing method.

The computer program codes for performing the operations of the present disclosure may be written in one or more programming languages or a combination thereof, where the programming languages include but are not limited to object-oriented programming languages, such as Java, Smalltalk, and C++, and further include conventional procedural programming languages, such as “C” language or similar programming languages. The program codes may be completely executed on a computer of a user, partially executed on a computer of a user, executed as an independent software package, partially executed on a computer of a user and partially executed on a remote computer, or completely executed on a remote computer or a server. In the case involving the remote computer, the remote computer may be connected to the computer of the user through any kind of network, including a local area network (LAN) or a wide area network (WAN), or may be connected to an external computer (for example, connected through the Internet using an Internet service provider).

Compared with the related art, the present application has at least the following advantages.

In the technical solutions provided in the present application, state information is provided by a server to a client, so that the state information is configured to indicate request processing performance of the server, and the state information may represent a request processing speed of the server to some extent. In this way, subsequently, when a playback progress of a first content sequence on the client reaches a progress threshold determined based on the state information, a first request is sent by the client to the server, so that the server with the request processing performance may feed a second content sequence back to the client, for playing and display after the first content sequence in response to the first request.

The progress threshold configured to indicate a triggering timing (such as a sending time) of the first request is determined based on the state information provided by the server, so that the triggering timing of the first request is dynamically adjusted with continuous changes in the request processing performance of the server, instead of being fixed. This may effectively overcome the defect that exists when the request triggering timing is fixed. In addition, the progress threshold is positively correlated with the request processing performance indicated by the state information, so that the progress threshold is relatively large when the server has a good request processing performance (for example, a relatively fast response speed for a request), and the progress threshold is relatively small when the server has a poor request processing performance (for example, a relatively slow response speed for a request). Therefore, when the server has a good request processing performance, the first request needs to be sent when the first content sequence is almost finished playing, to reduce a resource waste rate. When the server has a poor request processing performance, the first request needs to be sent soon after the first content sequence starts playing, to reduce waiting time.

It may be learned that the triggering timing of the first request has the following characteristics: The first request is triggered as late as possible when the server has a good request processing performance, to reduce as much as possible waste of both user traffic and service bandwidth resources consumed when the second content sequence is obtained in advance due to the user leaving after viewing some content in the first content sequence; and the first request is triggered as early as possible when the server has a poor request processing performance, to ensure that the client has successfully obtained the second content sequence from the server before the first content sequence is finished playing, so that continuity of content playing on the client may be ensured. This may effectively avoid deterioration of user experience caused by the user having to wait for a period of time when the second content sequence is not obtained after the first content sequence is finished playing, thereby effectively improving user experience.

Based on the foregoing characteristics, it may be learned that the technical solutions provided in the present application may better improve the balance between user experience and resource waste by dynamically determining the request triggering timing based on the actual request processing performance of the server, so that user experience may be improved on the premise that resource waste is reduced as much as possible.

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of codes, and the module, program segment, or part of codes contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by software or by hardware. The name of a unit/a module does not constitute a limitation on the unit itself under certain circumstances.

The functions described above herein may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more lines, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

It should be noted that the embodiments in this specification are described in a progressive manner, each embodiment focuses on the differences from other embodiments, and the same or similar parts between the embodiments may be referred to each other. For the system or apparatus disclosed in the embodiments, since it corresponds to the method disclosed in the embodiments, the description is relatively simple, and for the related parts, reference may be made to the description of the method part.

It should be understood that in the present application, “at least one item” means one or more, and “a plurality of” means two or more. “And/or” describes an association relationship between associated objects, and represents that three relationships may exist. For example, “A and/or B” may represent the following three cases: Only A exists, only B exists, and both A and B exist, where A and B may be singular or plural. The character “/” generally indicates an “or” relationship between the associated objects. “At least one of the following items (pieces)” or a similar expression thereof indicates any combination of these items, including a single item (piece) or any combination of a plurality of items (pieces). For example, at least one of a, b, or c may represent: a, b, c, “a and b”, “a and c”, “b and c”, or “a, b, and c”, where a, b, and c may be singular or plural.

It should be further noted that in this paper, relational terms such as first and second are used only to distinguish one entity or operation from another entity or operation, and do not necessarily require or imply any actual relationship or order between these entities or operations. Moreover, the terms “include”, “comprise”, or any other variant thereof are intended to cover non-exclusive inclusion, so that a process, method, object, or device that includes a series of elements includes not only those elements, but also other elements not explicitly listed or elements inherent to such process, method, object, or device. Without further restrictions, an element defined by the phrase “includes a . . . ” does not exclude that there are other identical elements in the process, method, object, or device that includes the element.

The steps of the method or algorithm described in conjunction with the embodiments disclosed herein may be directly implemented by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or any other form of storage medium known in the art.

The foregoing descriptions of the disclosed embodiments enable those skilled in the art to implement or use the present application. Various modifications to these embodiments will be readily apparent to those skilled in the art, and the generic principles defined herein may be implemented in other embodiments without departing from the spirit or scope of the present application. Therefore, the present application is not limited to the embodiments shown herein, but is to be accorded the widest scope consistent with the principles and novel features disclosed herein.

1. A processing method, wherein the method is applied to a client, and the method comprises:
receiving state information provided by a server, wherein the state information is configured to indicate request processing performance of the server; and
sending a first request to the server in response to a playback progress of a first content sequence on the client reaching a first threshold determined based on the state information, wherein the first threshold is positively correlated with the request processing performance, the first request is configured to request a second content sequence, and a playback time of a content at the first position in the second content sequence on the client is later than a playback time of a content at the tail position in the first content sequence on the client.

2. The method of claim 1, wherein the state information is provided by the server in response to a second request sent by the client, and a sending time of the second request is earlier than a sending time of the first request.

3. The method of claim 2, wherein the state information is determined based on a ratio of a number of requests borne by the server at a receiving time of the second request to a maximum number of bearable requests, the maximum number of bearable requests is obtained through quantity statistical analysis of requests borne by the server at various times in a historical time period, the first threshold is negatively correlated with the ratio, and the various times in the historical time period are earlier than the receiving time of the second request.

4. The method of claim 2, wherein a determining process of the state information comprises:
partitioning, based on at least one parameter, requests borne by the server at various times in a historical time period, to obtain at least one set, wherein there is no difference between parameter values of two requests partitioned into a same set under the at least one parameter, the at least one parameter comprises at least one of a physical location or a request type, and the various times in the historical time period are earlier than the receiving time of the second request;
performing, for any set, quantity statistical analysis on requests in the set, to obtain a maximum number of bearable requests corresponding to a parameter value of the set, wherein the parameter value of the set is configured to indicate parameter values of the requests in the set under the at least one parameter; and
in response to the second request sent by the client, based on a parameter value of the at least one parameter specified by the second request, searching the maximum numbers of bearable requests corresponding to the parameter values of the at least one set for a maximum number of bearable requests corresponding to the specified parameter value, and determining the state information based on a ratio of a number of requests borne by the server at the receiving time of the second request to the maximum number of bearable requests corresponding to the specified parameter value, wherein the specified parameter value is configured to indicate a parameter value of the first request under the at least one parameter.

5. The method of claim 2, wherein the second request is only configured to request the state information, and the second request is triggered in a polling manner.

6. The method of claim 2, wherein the second request is a previous request corresponding to the first request, and the previous request is configured to request the first content sequence and the state information.

7. The method of claim 6, wherein a sending time of a next request corresponding to the first request is determined based on state information fed back by the server for the first request, the sending time of the next request is later than the sending time of the first request, the next request is at least configured to request a third content sequence from the server, and a playback time of a content at the first position in the third content sequence on the client is later than a playback time of a content at the tail position in the second content sequence on the client.

8. The method of claim 6, wherein the method further comprises:
receiving validity information provided by the server for the state information, wherein the validity information is configured to indicate a valid time period of the first threshold determined based on the state information; and
sending the first request to the server in response to the playback progress of the first content sequence on the client reaching the first threshold determined based on the state information comprises:
sending the first request to the server in response to detecting, within the valid time period, that the playback progress of the first content sequence on the client reaches the first threshold.

9. The method of claim 8, wherein the method further comprises:
sending a third request to the server in a polling manner in response to the playback progress of the first content sequence on the client not reaching the first threshold at an end time indicated by the valid time period, wherein a sending time of the third request is later than the end time; and
sending the first request to the server in response to the playback progress of the first content sequence on the client reaching a second threshold determined based on state information fed back by the server for the third request.

10. The method of claim 6, wherein the validity information provided by the server for the state information is determined based on the state information, a receiving time of the second request, and a change rule of the number of received requests obtained through quantity statistical analysis of requests received by the server at various times in a historical time period.

11. The method of claim 1, wherein before sending the first request to the server, the method further comprises:
updating at least one timeout threshold based on the state information, wherein the at least one updated timeout threshold is configured to constrain at least part of stages in a sending process of the first request, each updated timeout threshold is negatively correlated with the request processing performance, the at least one updated timeout threshold comprises a connection establishment timeout threshold, and the connection establishment timeout threshold is configured to indicate a maximum value of a duration consumed for establishing a data transmission connection between the client and the server for the first request.

12. An electronic device, wherein the device comprises a processor and a memory, wherein
the memory is configured to store instructions or a computer program; and
the processor is configured to execute the instructions or the computer program in the memory to enable the electronic device to perform a processing method, wherein the method is applied to a client, and the method comprises:
receiving state information provided by a server, wherein the state information is configured to indicate request processing performance of the server; and
sending a first request to the server in response to a playback progress of a first content sequence on the client reaching a first threshold determined based on the state information, wherein the first threshold is positively correlated with the request processing performance, the first request is configured to request a second content sequence, and a playback time of a content at the first position in the second content sequence on the client is later than a playback time of a content at the tail position in the first content sequence on the client.

13. The electronic device of claim 12, wherein the state information is provided by the server in response to a second request sent by the client, and a sending time of the second request is earlier than a sending time of the first request.

14. The electronic device of claim 13, wherein the state information is determined based on a ratio of a number of requests borne by the server at a receiving time of the second request to a maximum number of bearable requests, the maximum number of bearable requests is obtained through quantity statistical analysis of requests borne by the server at various times in a historical time period, the first threshold is negatively correlated with the ratio, and the various times in the historical time period are earlier than the receiving time of the second request.

15. The electronic device of claim 13, wherein a determining process of the state information comprises:
partitioning, based on at least one parameter, requests borne by the server at various times in a historical time period, to obtain at least one set, wherein there is no difference between parameter values of two requests partitioned into a same set under the at least one parameter, the at least one parameter comprises at least one of a physical location or a request type, and the various times in the historical time period are earlier than the receiving time of the second request;
performing, for any set, quantity statistical analysis on requests in the set, to obtain a maximum number of bearable requests corresponding to a parameter value of the set, wherein the parameter value of the set is configured to indicate parameter values of the requests in the set under the at least one parameter; and
in response to the second request sent by the client, based on a parameter value specified by the second request under the at least one parameter, searching the maximum numbers of bearable requests corresponding to the parameter values of the at least one set for a maximum number of bearable requests corresponding to the specified parameter value, and determining the state information based on a ratio of a number of requests borne by the server at the receiving time of the second request to the maximum number of bearable requests corresponding to the specified parameter value, wherein the specified parameter value is configured to indicate a parameter value of the first request under the at least one parameter.

16. The electronic device of claim 13, wherein the second request is only configured to request the state information, and the second request is triggered in a polling manner.

17. A non-transitory computer-readable medium, wherein the computer-readable medium stores instructions or a computer program, and when the instructions or the computer program runs on a device, the device is enabled to perform a processing method, wherein the method is applied to a client, and the method comprises:
receiving state information provided by a server, wherein the state information is configured to indicate request processing performance of the server; and
sending a first request to the server in response to a playback progress of a first content sequence on the client reaching a first threshold determined based on the state information, wherein the first threshold is positively correlated with the request processing performance, the first request is configured to request a second content sequence, and a playback time of a content at the first position in the second content sequence on the client is later than a playback time of a content at the tail position in the first content sequence on the client.

18. The non-transitory computer-readable medium of claim 17, wherein the state information is provided by the server in response to a second request sent by the client, and a sending time of the second request is earlier than a sending time of the first request.

19. The non-transitory computer-readable medium of claim 18, wherein the state information is determined based on a ratio of n number of requests borne by the server at a receiving time of the second request to a maximum number of bearable requests, the maximum number of bearable requests is obtained through quantity statistical analysis of requests borne by the server at various times in a historical time period, the first threshold is negatively correlated with the ratio, and the various times in the historical time period are earlier than the receiving time of the second request.

20. The non-transitory computer-readable medium of claim 18, wherein a determining process of the state information comprises:
partitioning, based on at least one parameter, requests borne by the server at various times in a historical time period, to obtain at least one set, wherein there is no difference between parameter values of two requests partitioned into a same set under the at least one parameter, the at least one parameter comprises at least one of a physical location or a request type, and the various times in the historical time period are earlier than the receiving time of the second request;
performing, for any set, quantity statistical analysis on requests in the set, to obtain a maximum number of bearable requests corresponding to a parameter value of the set, wherein the parameter value of the set is configured to indicate parameter values of the requests in the set under the at least one parameter; and
in response to the second request sent by the client, based on a parameter value specified by the second request under the at least one parameter, searching the maximum numbers of bearable requests corresponding to the parameter values of the at least one set for a maximum number of bearable requests corresponding to the specified parameter value, and determining the state information based on a ratio of a number of requests borne by the server at the receiving time of the second request to the maximum number of bearable requests corresponding to the specified parameter value, wherein the specified parameter value is configured to indicate a parameter value of the first request under the at least one parameter.
